(19) United States
(12) Patent Application Publication
(10) Pub. No.: US 2017/0232917 A1
(43) Pub. Date: Aug. 17, 2017

(54) VEHICLE BUMPER BEAM

(71) Applicant: TOYODA IRON WORKS CO., LTD., Toyota-shi, Aichi (JP)

(72) Inventors: Takeshi NAKAYAMA, Toyota-shi (JP); Akira OBAYASHI, Toyota-shi (JP)

(73) Assignee: TOYODA IRON WORKS CO., LTD., Toyota-shi, Aichi (JP)

(21) Appl. No.: 15/503,202

(22) PCT Filed: Aug. 5, 2015
(86) PCT No.: PCT/JP2015/072291

§ 371 Date: Feb. 10, 2017

(30) Foreign Application Priority Data
Sep. 4, 2014 (JP) 2014-180190

(51) Int. Cl. B60R 19/04

(52) U.S. Cl. CPC B60R 19/04

(57) ABSTRACT

A vehicle bumper beam including an outer member, and an inner member such that a pair of second standing walls of the inner member are configured to be tilted at a tilt angle of 20° or less so as to open outward and symmetrically in the vertical direction as the second standing walls extend farther away from an inner member second projecting wall, and a pair of first standing walls of the outer member are configured to be tilted at substantially the same angle as the tilt angle of the second standing walls so as to open outward and symmetrically in the vertical direction as the first standing walls extend farther away from a first projecting wall.

### TECHNICAL FIELD

The present invention relates to vehicle bumper beams, and more particularly to improvement in vehicle bumper beams that are formed by placing on each other a pair of outer and inner members each having such a hat section along the vertical direction of a vehicle that opens horizontally, and fixedly joining the outer and inner members.

### BACKGROUND ART

Vehicle bumper beams are known which include (a) an outer member that has a first projecting wall extending in the vertical direction of a vehicle, a pair of first standing walls extending from the upper and lower ends of the first projecting wall toward the inside of the vehicle, and a pair of first flange portions extending outward in the vertical direction of the vehicle from the distal ends of the first standing walls, and that has such a hat (brimmed-hat) section along the vertical direction of the vehicle that opens horizontally, the hat section being symmetrical with respect to a substantially horizontal centerline of the outer member, and (b) an inner member that has a second projecting wall extending in the vertical direction of the vehicle, a pair of second standing walls extending from the upper and lower ends of the second projecting wall toward the inside of the vehicle, and a pair of second flange portions extending outward in the vertical direction of the vehicle from the distal ends of the second standing walls, and that has such a hat section along the vertical direction of the vehicle that opens horizontally, the hat section being symmetrical with respect to a substantially horizontal centerline of the inner member, the vertical dimension of the second projecting wall being smaller than that of the first projecting wall, the inner member being fixedly joined to the outer member by placing the inner member on the inner side of the outer member so that the inner member is located on the inner side of the vehicle with the centerlines of the outer and inner members being aligned with each other such that the second projecting wall is located between the pair of first standing walls and spaces are formed between the pair of first standing walls and the pair of second standing walls, and placing the inner member and the outer member on each other such that the second flange portions closely contact the first flange portions, (c) the vehicle bumper beam being disposed in the front or rear end of the vehicle so as to extend in the lateral direction of the vehicle, and being supported at its both ends in the lateral direction of the vehicle. An example of such vehicle bumper beams is described in Patent Document 1. Since the spaces are formed between the pair of first standing walls of the outer member and the pair of second standing walls of the inner member, rigidity is increased and excellent impact energy absorption capability is achieved.

### RELATED ART

### Patent Documents

Patent Document 1: Japanese Translation of PCT Application No. 2008-504162

### SUMMARY OF THE INVENTION

### Problem to be Solved by the Invention

However, the vehicle bumper beam described in Patent Document 1 has the following problems. The pair of second standing walls of the inner member are tilted so as to open outward and symmetrically in the vertical direction as the second standing walls extend farther away from the second projecting wall, whereas the pair of first standing walls of the outer member are bent substantially at right angles to the first projecting wall and extend substantially horizontally so as to be parallel to the centerline. Accordingly, when these standing walls are bent and buckled into a V-shape or U-shape so as to project outward in the vertical direction, deformation of the first standing walls and deformation of the second standing walls are different from each other and affect each other, causing instability. Such instability may result in variation in impact energy absorption capability. If the tilt angle of the second standing walls is increased, opening deformation occurs, namely the second and first standing walls are opened outward in the vertical direction without being buckled. Accordingly, appropriate impact energy absorption capability cannot be obtained.

The present invention was developed in view of the above circumstances, and it is an object of the present invention to stably obtain predetermined impact energy absorption capability of a vehicle bumper beam that is formed by placing on each other a pair of outer and inner members each having such a hat section that opens horizontally, and fixedly joining the outer and inner members.

### Solution to Problem

To achieve the above object, the principle of the present invention provides a vehicle bumper beam including (a) an outer member that has a first projecting wall extending in a vertical direction of a vehicle, a pair of first standing walls extending from upper and lower ends of the first projecting wall toward inside of the vehicle, and a pair of first flange portions extending outward in the vertical direction of the vehicle from distal ends of the first standing walls, and that has such a hat section along the vertical direction of the vehicle that opens horizontally, the hat section being symmetrical with respect to a substantially horizontal centerline of the outer member, and (b) an inner member that has a second projecting wall extending in the vertical direction of the vehicle, a pair of second standing walls extending from upper and lower ends of the second projecting wall toward the inside of the vehicle, and a pair of second flange portions extending outward in the vertical direction of the vehicle from distal ends of the second standing walls, and that has such a hat section along the vertical direction of the vehicle that opens horizontally, the hat section being symmetrical with respect to a substantially horizontal centerline of the inner member, the second projecting wall having a vertical dimension smaller than the first projecting wall, the inner member being fixedly joined to the outer member by placing the inner member on an inner side of the outer member so that the inner member is located on an inner side of the vehicle with the centerlines of the outer and inner members being aligned with each other such that the second projecting wall is located between the pair of first standing walls and spaces are formed between the pair of first standing walls and the pair of second standing walls, and placing the inner member and the outer member on each other such that the second flange portions closely contact the first flange portions, (c) the vehicle bumper beam being disposed in a front or rear end of the vehicle so as to extend in a lateral direction of the vehicle, and being supported at its both ends in the lateral direction of the vehicle, characterized in that (d) the pair of second standing walls of the inner member are tilted at a tilt angle of 20° or less so as to open outward and symmetrically in the vertical direction as the second standing walls extend farther away from the second projecting wall, and (e) the pair of first standing walls of the outer member are tilted at substantially the same angle as the tilt angle of the second standing walls so as to open outward and symmetrically in the vertical direction as the first standing walls extend farther away from the first projecting wall.

The expression “substantially the same angle” is used herein in view of variation in shape due to spring-back etc. For example, the difference in tilt angle between the first and second standing walls is about 2° to 3° or less, although it depends on the material etc.

### Advantageous Effects of the Invention

In such a vehicle bumper beam, the pair of first standing walls of the outer member and the pair of second standing walls of the inner member are tilted so as to open outward in the vertical direction, and the tilt angles are substantially the same, so that the first standing walls and the second standing walls are substantially parallel to each other.

Accordingly, when the standing walls are bent and buckled into a V-shape or U-shape so as to project outward in the vertical direction, the first standing walls and the second standing walls which are substantially parallel to each other are deformed synchronously with each other or are deformed so as to follow each other's deformation. Namely, buckling deformation of the first and second standing walls of the outer and inner members occurs always substantially in the same manner. Predetermined impact energy absorption capability is therefore stably obtained.

Since the tilt angle of the first and second standing walls is 20° or less, such opening deformation that the first and second standing walls are opened in the vertical direction without being buckled is appropriately prevented, and impact energy absorption capability based on buckling is stably obtained. In the case where the first standing walls and the second standing walls are tilted so as to open outward in the vertical direction, the bending angle of the first projecting wall and the second projecting wall is an obtuse angle. This improves bending workability of the inner member and the outer member with a press.

### BRIEF DESCRIPTION OF DRAWINGS

FIG. 1 is a schematic plan view showing, together with a bumper and side members, a vehicle bumper beam according to an embodiment of the present invention, as viewed from above a vehicle.

FIG. 2 is an enlarged sectional view taken along line II-II and viewed in the direction of arrows II in FIG. 1.

FIG. 3 is an enlarged sectional view of the upper half of FIG. 2.

FIG. 4 is a graph showing the results of examining the initial load and the energy absorption by varying tilt angles θ1, θ2 in FIG. 3.

FIG. 5 is a conceptual diagram illustrating buckling deformation of the vehicle bumper beam of FIG. 1 and showing a section corresponding to FIG. 2.

FIG. 6 is a conceptual diagram illustrating opening deformation of the vehicle bumper beam and showing a section corresponding to FIG. 5.

### MODES FOR CARRYING OUT THE INVENTION

The vehicle bumper beam of the present invention may be a bumper beam that is disposed on the front side of the vehicle or a bumper beam that is disposed on the rear side of the vehicle, and may be applied only to one of the front and rear sides of the vehicle. For example, the longitudinal shape of the bumper beam, namely the shape of the bumper beam as viewed in plan from above the vehicle, is a smoothly curved shape that is curved toward the outside of the vehicle (toward the front in the case of the front bumper beam, and toward the rear in the case of the rear bumper beam) in the middle. The bumper beam may have various longitudinal shapes. For example, the longitudinal shape of the bumper beam may be a substantially linear shape, or only both ends of the bumper beam may be tilted or curved toward a vehicle body.

For example, each of the outer member and the inner member has such a hat section along the vertical direction of the vehicle that opens horizontally, and has this hat section along the entire longitudinal length of the vehicle bumper beam, and the outer member and the inner member are placed on each other such that the first flange portions closely contact the second flange portions, and are fixedly joined together. However, the vehicle bumper beam need not necessarily have the above configuration along its entire longitudinal length. For example, the vehicle bumper beam may have the above configuration only in its intermediate portion located inside attachment portions that are fixed to the vehicle body. It is desirable that the first projecting wall and the second projecting wall closely contact each other. However, there may be clearance between the first and second projecting walls. The first projecting wall and the second projecting wall may be fixedly joined by welding etc. as necessary. The vertical dimension of the second flange portions needs only to be at least large enough for the second flange portions to reach the first flange portions and to be fixedly joined to the first flange portions. However, it is desirable that the vertical dimension of the second flange portions be larger than that of the first flange portions so that the upper and lower ends of the second flange portions reach the upper and lower ends of the first flange portions. Appropriate means for joining the inner and outer members is welding such as resistance welding. However, other means such as bending and crimping may be used.

The first standing walls and the second standing walls are tilted so as to open outward in the vertical direction, and the tilt angle is larger than 0° and 20° or less. In order to ensure press workability, it is desirable that the tilt angle be 3° or more. In order to more reliably prevent opening deformation that reduces impact energy absorption capability, it is desirable that the tilt angle be 15° or less.

### EMBODIMENT

An embodiment of the present invention will be described in detail below with reference to the accompanying drawings. In the following embodiment, the drawings are shown simplified or deformed as appropriate for explanation purposes, and the dimensions, proportions, angles, shapes, etc. of the parts are not necessarily accurately shown in the drawings.

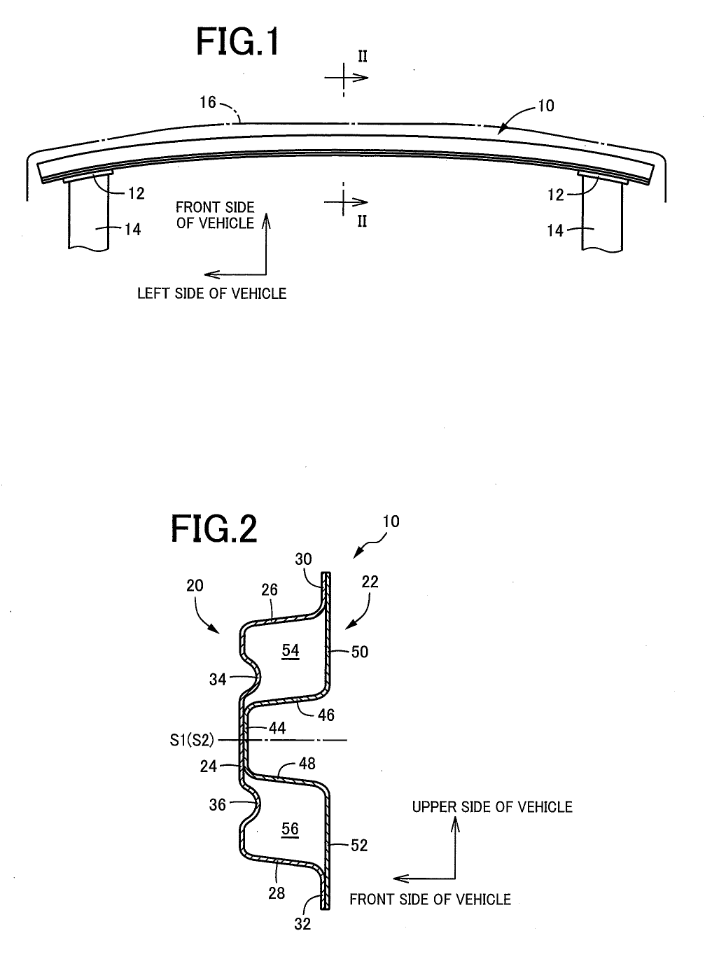

A vehicle bumper beam (hereinafter also simply referred to as the “bumper beam”) 10 in FIG. 1 is disposed on the front side of a vehicle so as to extend in the lateral direction of the vehicle. FIG. 1 is a schematic plan view of the bumper beam 10 disposed in the vehicle as viewed from above, and the upper side of the figure corresponds to the front side of the vehicle. The bumper beam 10 has an elongated shape that is long in the lateral direction of FIG. 1, namely in the lateral direction of the vehicle. The bumper beam 10 is fixedly attached at its both ends to the front ends of side members 14 of a vehicle body via a pair of attachment portions 12, and is thus supported at its both ends. A bumper 16 made of a synthetic resin is disposed on the outer side (front side of the vehicle) of the bumper beam 10.

The bumper beam 10 has substantially the same sectional shape along its entire longitudinal length. FIG. 2 is an enlarged sectional view taken along line II-II and viewed in the direction of arrows II in FIG. 1, and the bumper beam 10 is vertically symmetrical with respect to substantially horizontal centerlines S1, S2. As can be seen from FIG. 2, the bumper beam 10 includes a pair of outer and inner members 20, 22. The outer member 20 has a first projecting wall 24 extending in the vertical direction of the vehicle, a pair of first standing walls 26, 28 extending from the upper and lower ends of the first projecting wall 24 toward the inside of the vehicle, and a pair of first flange portions 30, 32 extending outward in the vertical direction of the vehicle from the distal ends of the first standing walls 26, 28. The outer member 20 has such a hat section along the vertical direction of the vehicle that opens horizontally and that is symmetrical with respect to the substantially horizontal centerline S1. A pair of beads 34, 36, which are bent so as to be recessed in a semicircular arc shape, are formed in the first projecting wall 24 so as to be separated from each other in the vertical direction and to extend in the longitudinal direction, namely in the lateral direction of the vehicle. The outer member 20 is formed by processing such as bending of a metal plate material by a press. Each of the corners between the first projecting wall 24 and the first standing walls 26, 28 and the corners between the first standing walls 26, 28 and the first flange portions 30, 32 is curved into an arc shape with a predetermined radius.

The inner member 22 has a second projecting wall 44 extending in the vertical direction of the vehicle, a pair of second standing walls 46, 48 extending from the upper and lower ends of the second projecting wall 44 toward the inside of the vehicle, and a pair of second flange portions 50, 52 extending outward in the vertical direction of the vehicle from the distal ends of the second standing walls 46, 48. The inner member 22 has such a hat section along the vertical direction of the vehicle that opens horizontally and that is symmetrical with respect to the substantially horizontal centerline S2. The inner member 22 is also formed by processing such as bending of a metal plate material by a press. Each of the corners between the second projecting wall 44 and the second standing walls 46, 48 and the corners between the second standing walls 46, 48 and the second flange portions 50, 52 is curved into an arc shape with a predetermined radius.

The vertical dimension of the second projecting wall 44 of the inner member 22 is smaller than that of the first projecting wall 24. The inner member 22 is fixedly joined to the outer member 20 by resistance welding etc. by placing the inner member 22 on the inner side of the outer member 20 so that the inner member 22 is located on the inner side of the vehicle with the centerlines S1, S2 being substantially aligned with each other such that the second projecting wall 44 is located between the pair of first standing walls 26, 28 and spaces 54, 56 are formed between the pair of first standing walls 26, 28 and the pair of second standing walls 46, 48, and placing the inner member 22 and the outer member 20 on each other such that the second flange portions 50, 52 closely contact the first flange portions 30, 32. The dimension by which the first projecting wall 24 of the outer member 20 projects is substantially the same as that by which the second projecting wall 44 of the inner member 22 projects. The vertical dimension of the second projecting wall 44 is smaller than the interval between the pair of beads 34, 36. The inner member 22 and the outer member 20 are placed on each other such that the first flange portions 30, 32 closely contact the second flange portions 50, 52, and are fixedly joined together. The second projecting wall 44 thus closely contacts the inner wall surface of the first projecting wall 24 in a region located between the pair of beads 34, 36. The vertical dimension of the pair of second flange portions 50, 52 is sufficiently larger than that of the first flange portions 30, 32 so that the second flange portion 50 reaches the upper end of the first flange portion 30 and the second flange portion 52 reaches the lower end of the first flange portion 32. The upper and lower ends of the outer member 20 and the upper and lower ends of the inner member 22 are thus substantially aligned with each other.

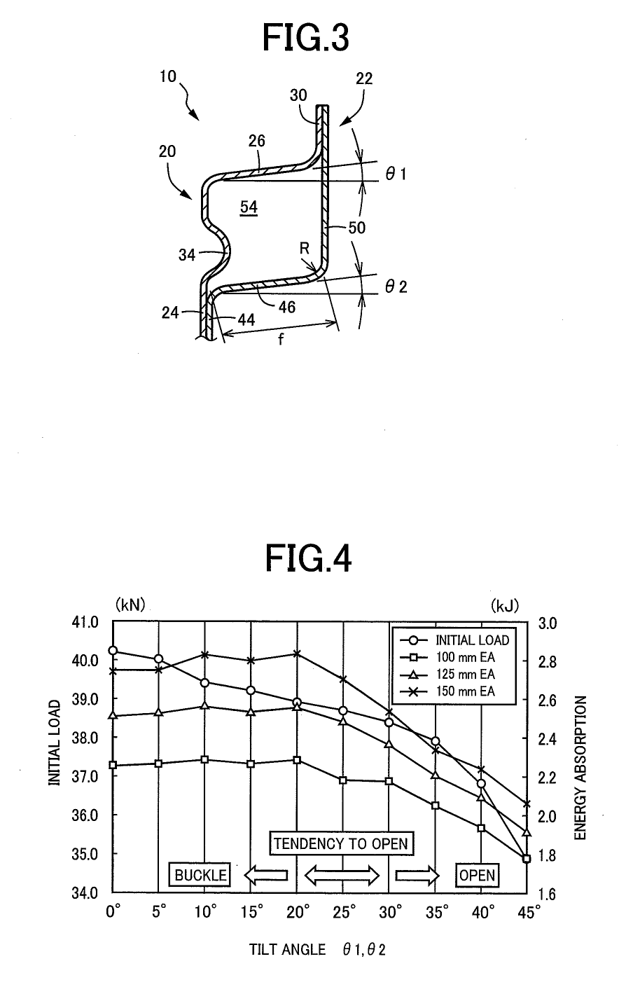

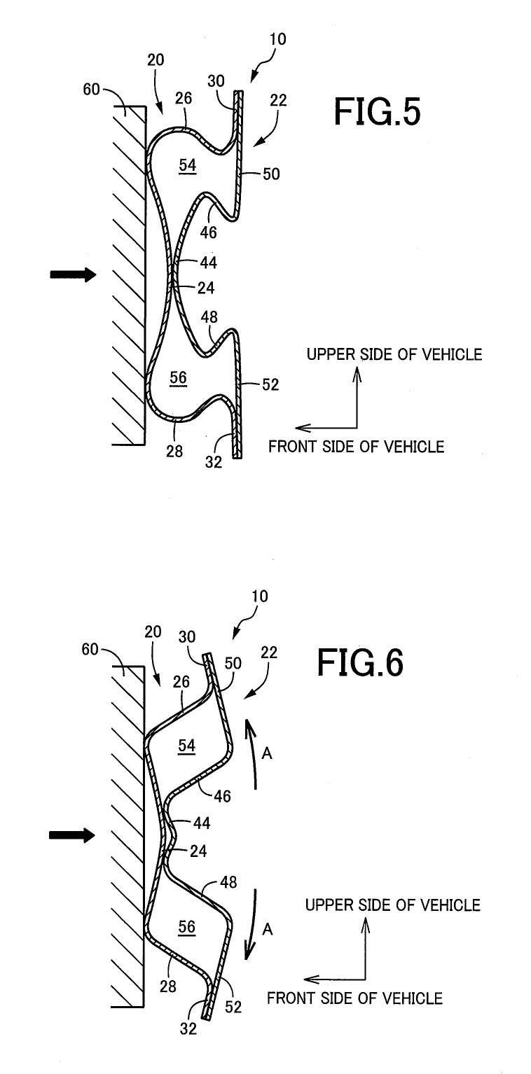

The pair of first standing walls 26, 28 of the outer member 20 are tilted so as to open outward and symmetrically in the vertical direction as the first standing walls 26, 28 extend farther away from the first projecting wall 24. The pair of second standing walls 46, 48 of the inner member 22 are also tilted so as to open outward and symmetrically in the vertical direction as the second standing walls 46, 48 extend farther away from the second projecting wall 44. FIG. 3 is an enlarged sectional view of the upper half of FIG. 2. The tilt angle θ1 of the first standing wall 26 and the tilt angle θ2 of the second standing wall 46 are substantially equal to each other. The tilt angles θ1, θ2 are 20° or less, and desirably 15° or less, in order to restrain opening deformation shown in FIG. 6 and to cause buckling deformation as shown in FIG. 5. If the tilt angles θ1, θ2 are small, bending workability with a press is reduced. Accordingly, the tilt angles θ1, θ2 are larger than 0°, and desirably 3° or more. The tilt angles η1, η2 are therefore desirably in the range of 3° to 15°, and are about 7° in the present embodiment.

FIG. 4 shows the results of examining the initial load and the energy absorption (EA) by finite element method (FEM) analysis and computer aided engineering (CAE) using a three-point bending model for a total of ten kinds of samples with the tilt angles θ1, θ2 varied in increments of 5° from 0° to 45°. The initial load is a maximum load due to deformation resistance at the time the bumper beam 10 is deformed, and the energy absorption is values at three positions corresponding to compression strokes on the bumper beam 10 of 100 mm, 125 mm, and 150 mm. As can be seen from the results of FIG. 4, the initial load is the largest when the tilt angles θ1, θ2 are 0°. The initial load gradually decreases as the tilt angles θ1, θ2 increase. The initial load decreases rapidly when the tilt angles θ1, θ2 are equal to or larger than 35°. The energy absorption has substantially the same tendency for each compression stroke. When the tilt angles θ1, θ2 are 20° or less, the energy absorption is substantially constant and high energy absorption capability is obtained. However, the energy absorption gradually decreases as the tilt angles θ1, θ2 become larger than 20°. Four kinds of samples with the tilt angles θ1, θ2 of 5°, 10°, 15°, and 20° are the products of the present invention, and the remaining samples are the comparative products.

FIGS. 5 and 6 are conceptual diagrams illustrating how the bumper beam 10 is deformed, and showing the bumper beam 10 being perpendicularly pressed by an impact piece 60 with an arc-shaped (semicircular) distal end from the front side of the vehicle. When the tilt angles θ1, θ2 are 20° or less, buckling deformation occurs in such a manner that all of the standing walls 26, 28, 46, 48 of the outer and inner members 20, 22 are bent into a V-shape or U-shape so as to project outward in the vertical direction, as shown in FIG. 5. The impact load is thus appropriately received by the deformation resistance of the standing walls 26, 28, 46, 48, and excellent energy absorption capability is obtained. When the tilt angles θ1, θ2 are 30° or more, opening deformation occurs in such a manner that the standing walls 26, 28, 46, 48 are opened outward in the vertical direction as shown by arrows A without being bent and the projecting walls 24, 44 are bent at their intermediate positions, as shown in FIG. 6. The deformation resistance is thus low and sufficient energy absorption capability is not obtained. When the tilt angles θ1, θ2 are 25°, buckling deformation occurs with a tendency to open, namely buckling deformation occurs in such a manner that the standing walls 26, 28, 46, 48 are opened outward as shown by arrows A in FIG. 6 and are also bent and buckled into a V-shape or U-shape.

The radius R in FIG. 3, namely the radius R of the arc of the corners between the second standing walls 46, 48 and the second flange portions 50, 52 of the inner member 22, also affects how the bumper beam 10 is deformed. As the radius R of the arc increases, opening deformation is more likely to occur as in the case where the tilt angle θ2 is increased. In the present embodiment, the radius R is therefore set to 1/4 or less of the length dimension f of the second standing walls 46, 48. In the present embodiment, the length dimension f is 40 mm and the radius R is 10 mm or less. If the radius R is small, bending workability with a press is reduced. Accordingly, an appropriate value of the radius R is 2 mm or more. The radius R is set in the range of 2 to 10 mm, and is about 7 mm in the present embodiment. The radii of the arcs of the corners between the second projecting wall 44 and the second standing walls 46, 48, the corners between the first projecting wall 24 and the first standing walls 26, 28 of the outer member 20, and the corners between the first standing walls 26, 28 and the first flange portions 30, 32 of the outer member 20 are also set to substantially the same value as the radius R.

In such a vehicle bumper beam 10 of the present embodiment, the pair of first standing walls 26, 28 of the outer member 20 and the pair of second standing walls 46, 48 of the inner member 22 are tilted so as to open outward in the vertical direction, and the tilt angles θ1, θ2 are substantially the same, so that the first standing wall 26 and the second standing wall 46 are substantially parallel to each other and the first standing wall 28 and the second standing wall 48 are substantially parallel to each other. Accordingly, when the standing walls 26, 28, 46, 48 are bent and buckled into a V-shape or U-shape so as to project outward in the vertical direction, the first standing wall 26 and the second standing wall 46 which are parallel to each other and the first standing wall 28 and the second standing wall 48 which are parallel to each other are deformed synchronously with each other or are deformed so as to follow each other's deformation. Namely, buckling deformation of the standing walls 26, 28, 46, 48 of the outer and inner members 20, 22 occurs always substantially in the same manner. Predetermined impact energy absorption capability is therefore stably obtained.

The tilt angles θ1, θ2, namely the angles by which the first standing walls 26, 28 and the second standing walls 46, 48 open outward in the vertical direction, are 20° or less. Accordingly, opening deformation as shown in FIG. 6 is appropriately prevented, and impact energy absorption capability based on buckling is stably obtained. In the case where the first standing walls 26, 28 and the second standing walls 46, 48 are tilted so as to open outward in the vertical direction as described above, each of the bending angle of the first projecting wall 24 to the first standing walls 26, 28 and the second projecting wall 44 to the second standing walls 46, 48 is an obtuse angle. This improves bending workability of the outer member 20 and the inner member 22 with a press.

Although the embodiment of the present invention is described in detail above based on the drawings, the embodiment is shown by way of example only, and the present invention can be embodied in various modified or improved forms based on the knowledge of those skilled in the art. cl REFERENCE SIGNS LIST

10: Vehicle bumper beam 20: Outer member 22: Inner member 24: First projecting wall 26, 28: First standing wall 30, 32: First flange portion 44: Second projecting wall 46, 48: Second standing wall 50, 52: Second flange portion 54, 56: Space S1, S2: Centerline θ1, θ2: Tilt angle

1. A vehicle bumper beam including
an outer member that has a first projecting wall extending in a vertical direction of a vehicle, a pair of first standing walls extending from upper and lower ends of the first projecting wall toward inside of the vehicle, and a pair of first flange portions extending outward in the vertical direction of the vehicle from distal ends of the first standing walls, and that has such a hat section along the vertical direction of the vehicle that opens horizontally, the hat section being symmetrical with respect to a substantially horizontal centerline of the outer member, and
an inner member that has a second projecting wall extending in the vertical direction of the vehicle, a pair of second standing walls extending from upper and lower ends of the second projecting wall toward the inside of the vehicle, and a pair of second flange portions extending outward in the vertical direction of the vehicle from distal ends of the second standing walls, and that has such a hat section along the vertical direction of the vehicle that opens horizontally, the hat section being symmetrical with respect to a substantially horizontal centerline of the inner member, the second projecting wall having a vertical dimension smaller than the first projecting wall, the inner member being fixedly joined to the outer member by placing the inner member on an inner side of the outer member so that the inner member is located on an inner side of the vehicle with the centerlines of the outer and inner members being aligned with each other such that the second projecting wall is located between the pair of first standing walls and spaces are formed between the pair of first standing walls and the pair of second standing walls, and placing the inner member and the outer member on each other such that the second flange portions closely contact the first flange portions, the vehicle bumper beam being disposed in a front or rear end of the vehicle so as to extend in a lateral direction of the vehicle, and being supported at its both ends in the lateral direction of the vehicle,
the pair of second standing walls of the inner member are configured to be tilted at a tilt angle of 20° or less so as to open outward and symmetrically in the vertical direction as the second standing walls extend farther away from the second projecting wall, and
the pair of first standing walls of the outer member configured to be tilted at substantially the same angle as the tilt angle of the second standing walls so as to open outward and symmetrically in the vertical direction as the first standing walls extend farther away from the first projecting wall.
